(19) United States
(12) Patent Application Publication
(10) Pub. No.: US 2014/0333724 A1
(43) Pub. Date: Nov. 13, 2014

(54) IMAGING DEVICE, IMAGING METHOD AND PROGRAM STORAGE MEDIUM

(71) Applicant: FUJIFILM Corporation, Tokyo (JP)

(72) Inventor: Shunta EGO, Saitama-shi (JP)

(21) Appl. No.: 14/340,149

(22) Filed: Jul. 24, 2014

Related U.S. Application Data
(63) Continuation of application No. PCT/JP2013/051215, filed on Jan. 22, 2013.

(30) Foreign Application Priority Data
Mar. 30, 2012 (JP) 2012-082558

(51) Int. Cl. H04N 13/02; H04N 13/04

(52) U.S. Cl. CPC H04N 13/0239; H04N 13/0409
USPC 348/46

(57) ABSTRACT

An imaging device includes: imaging units that capture a same object of imaging from different viewpoints; a detection unit that detects a subject from respective frame images; a range computing unit that, if plural subjects are detected, computes a range expressed by a difference between a maximum value and a minimum value among values relating to distances between the detected subjects and the corresponding imaging units; an adjusting unit that, if the difference between a range of a specific frame and a range of a frame immediately before or after the specific frame exceeds a threshold value, adjusts the range of the specific frame such that the difference is reduced; a parallax amount computing unit that computes a parallax amount corresponding to the adjusted range; and a stereoscopic image generation unit that generates a stereoscopic image from captured viewpoint images based on the computed parallax amount.

### CROSS-REFERENCE TO RELATED APPLICATIONS

This application is a continuation application of International Application No. PCT/JP2013/051215, filed on Jan. 22, 2013, which is incorporated herein by reference. Further, this application claims priority from Japanese Patent Application No. 2012-082558, filed on Mar. 30, 2012, the disclosure of which is incorporated by reference herein in their entirety.

### BACKGROUND OF THE INVENTION

1. Field of the Invention

The present invention relates to an imaging device, method and program storage medium.

2. Related Art

There has conventionally been proposed a binocular parallax detecting method that determines, as variations in pixel positions on left and right images, the binocular parallax variation amount that corresponds to a subject and the background or to plural subjects whose distances from the camera differ (see, for example, Japanese Patent Application Laid-Open (JP-A) No. H2-100589). In this method, at the time of determining the binocular parallax, the left and right images are subjected to two-dimensional Fourier transformation, and several candidates of the parallax displacement amount are computed by shift matching of the phase terms thereof. Thereafter, contour extraction and region determination of the subject are carried out for each of the left and right images, and a point at the inner side and several points at the outer side of these boundary points are made to correspond with the displacement amount candidates that were determined by using the two-dimensional Fourier transformation, and a binocular parallax amount of a stereo image, that includes both a background and subjects having differing parallax amounts, is determined.

Further, there is proposed a multiple viewpoint image display method that makes an entire image uniformly easy to view by varying the positional relationship between the convergence angle and the furthest distance, the shortest distance, and shifting images so as to offset the average value of the parallaxes of the images for example (see, for example, JP-A No. H10-32840).

However, when the method of JP-A No. H2-100589 is applied to video images for stereoscopic viewing and the binocular parallax amount s determined per one frame, in cases in which the variation in the binocular parallax amount between the frames is great, the video images may be difficult to view stereoscopically.

Further, in the method of JP-A No. H10-32840, a mechanism for varying the convergence angle is needed in order to obtain images that are easy to view stereoscopically.

### SUMMARY

In consideration of the above, the present invention is to provide an imaging device, method and program storage medium that can reduce variations in the parallax amount between frames and can obtain stereoscopic video images with improved visibility, without using a complex mechanism.

In order to achieve the above-described object, an aspect of the present invention is an imaging device including; plural imaging units that capture, continuously and one frame at a time, a same object of imaging from plural different viewpoints respectively; a detection unit that detects a subject from respective images of the frames captured by any one of the plural imaging units; a range computing unit that, if plural subjects are detected by the detection unit, computes a range expressed by a difference between a maximum value and a minimum value among values relating to distances between the respective detected subjects at the respective frames in which the plural subjects have been detected and a corresponding imaging unit of the imaging units; an adjusting unit that, if a difference between a range of a specific frame, whose range has been computed by the range computing unit, and a range of a frame captured immediately before or after the specific frame, exceeds a predetermined threshold value, adjusts the range of the specific frame such that the difference is reduced; a parallax amount computing unit that computes a parallax amount corresponding to the range computed by the range computing unit or the range adjusted by the adjusting unit, based on a predetermined relationship between ranges and parallax amounts; a stereoscopic image generation unit that generates a stereoscopic image corresponding to each frame, from plural viewpoint images captured by the respective imaging units, based on the parallax amount computed by the parallax amount computing unit; and a recording control unit that effects control so as to record, at a recording unit, the stereoscopic image generated by the stereoscopic image generation unit. The detection unit may determine whether or not a subject that has been detected in a frame immediately before a target frame of detection is detected in the target frame and, based on a result of the determination, the range computing unit may perform computation of a range or the adjusting unit performs adjustment of a range.

In accordance with the imaging device of the present aspect, the same object of imaging is captured, in continuation and one frame at a time, from plural different viewpoints respectively by the imaging unit. As a result, stereoscopic video images can be captured. Further, the detection unit detects a subject from the respective images of the frames captured by any one of the plural imaging unit. In a case in which plural subjects are detected by the detection unit, the range computing unit computes a range that is expressed by the difference between the maximum value and the minimum value of values relating to distances between the imaging unit and the respective detected subjects at the respective frames in which the plural subjects have been detected. On the basis of this range, the parallax amount of each frame is computed by the parallax amount computing unit. In this regard, if fluctuations in the range between frames are large, the fluctuations in the parallax amount between the frames also are large, and the stereoscopic video images will be difficult to view.

Therefore, in a case in which the difference between the range of the specific frame and the range of a frame, which has been captured immediately before or after the specific frame, exceeds a predetermined threshold value, the adjusting unit adjusts the range of the specific frame such that the difference becomes smaller. On the basis of a predetermined relationship between ranges and parallax amounts, the parallax amount computing unit computes a parallax amount that corresponds to the range computed by the range computing unit or the range adjusted by the adjusting unit. Then, on the basis of the parallax amount computed by the parallax amount computing unit, the stereoscopic image generation unit generates a stereoscopic image corresponding to each frame, from plural viewpoint images that have been captured by the respective imaging unit. The recording control unit effects control so as to record the stereoscopic image generated by the stereoscopic image generation unit on a recording unit.

In this way, if the difference between the range of the specific frame, that is based on values relating to the distances between the imaging unit and the respective subjects detected from the specific frame, and the range of the frame that is immediately before or after the specific frame, is large, the range of the specific frame is adjusted such that this difference becomes smaller, the appropriate parallax amount is computed from the range, and the image is recorded after being corrected in accordance with the parallax amounts. Therefore, variations in the parallax amount between frames are reduced and stereoscopic images with improved visibility can be obtained, without providing a complex mechanism for adjusting the convergence angle.

In the imaging device of the present aspect, the recording control unit may effect control so as to record, at the recording unit and in correspondence with the stereoscopic age, a parallax amount corresponding to the range adjusted by the adjusting unit. Due thereto, information that expresses the parallax amount can be added to the video file.

Further, the imaging device of the present aspect may further include a receiving unit that receives input of information expressing a display format of the stereoscopic image, rein the stereoscopic image generation unit may generate the stereoscopic image in a format that is adapted to the display format of the stereoscopic image expressed by the information received by the receiving unit. Due thereto, a video file can be recorded in a. stereoscopic image display format that the user desires.

Further, the imaging device of the present aspect may further include an input unit that inputs, from a connected display device, information expressing a display format of a stereoscopic image, wherein the stereoscopic image generation unit may generate the stereoscopic image in a format that is adapted to the display format of the stereoscopic image expressed by the information input from the input unit. Due thereto, a video file can be recorded in a stereoscopic image display format that corresponds to the display device.

Further, in the imaging device of the present aspect, the values relating to distances may be distances between the respective detected subjects and the corresponding imaging unit, or parallaxes of the respective detected subjects. As the distance between a subject and the imaging unit becomes farther, the parallax of the subject becomes smaller, and as the distance becomes nearer, the parallax becomes larger. Therefore, it can be said that the parallax of each subject is a value relating to the distance between the subject and the imaging unit. At the range computing unit, in a case in which the distance between each subject and the imaging unit is computed, a subject distance range, which is expressed by the difference between the maximum value and the minimum value of the distances, is computed as the range, and, in a case in which the parallax of each subject is computed, a parallax range, which is expressed by the difference between the maximum value and the minimum value of the parallaxes, is computed as the range.

Further, if the subject that has been detected in the frame immediately before the target frame is not detected in the target frame, the adjusting unit may determine that a difference between a range of the target frame and a range of the frame immediately before the target frame exceeds the predetermined threshold value, and may adjust the range of the target frame. In a case in which a subject, that has been used in computing the range of the frame that was captured immediately before or after, is not detected from the non-detection frame, there is a high possibility that the range is fluctuating greatly. Therefore, by adjusting the range of the non-detection frame, the variation in the parallax amount between frames can be reduced.

Further, if the subject that has been detected in the frame immediately before the target frame is detected in the target frame, the range computing unit may compute an amount of movement between frames of the subject detected by the detection unit, and may compute the range by excluding a subject for which the amount of movement exceeds a predetermined amount of movement. In this way, by excluding in advance a subject, whose amount of movement is large and at Which there is a strong possibility of leading to large fluctuations in the range between frames, so as to not be used in computation of the range, variations in the parallax amount between frames can be reduced.

Further, the range computing unit may exclude a subject for which a direction of movement of the subject is a direction along an optical axis of the corresponding imaging unit and for which the amount of movement exceeds the predetermined amount of movement. Because the range is the difference between the maximum value and the minimum value of the values relating to the distances between the subjects and the imaging unit, a subject, that moves in the optical axis direction and at which the distance between the subject and the imaging unit fluctuates greatly, is excluded from the computing.

Further, the imaging device of the present aspect can be structured to further include a registering unit that registers, in advance, a subject to be detected by the detection unit, wherein, if a subject that has been registered by the registering unit is detected by the detection unit, the range computing unit may compute the range by using the registered subject. Due thereto, subjects of particular interest may be registered in advance, variations in the parallax amount between frames of the subjects of interest may be reduced, and stereoscopic video images with improved visibility can be obtained.

Further, the imaging device of the present aspect can be structured to further include a registering unit that registers, in advance, a subject to be detected by the detection unit, wherein the range computing unit may compute the range by excluding a subject for which the amount of movement exceeds the predetermined amount of movement and that is a subject that is not registered by the registering unit. Or, the range computing unit may not exclude, from computation of the range, a subject for which the amount of movement exceeds the predetermined amount of movement, if the subject is a subject registered by the registering unit.

Further, if one subject is detected by the detection unit, the parallax amount computing unit may compute the parallax amount by using the subject as a crosspoint, and, if a subject is not detected by the detection unit, the parallax amount computing unit may compute the parallax amount by using a predetermined point as the crosspoint.

Another aspect of the present invention is an imaging method includes: capturing, by plural imaging units, continuously and one frame at a time, a same object of imaging from plural different viewpoints respectively; detecting a subject from respective images of the frames captured by any one of the plural imaging units; if plural subjects are detected, computing a range expressed by a difference between a maximum value and a minimum value of values relating to distances between the respective detected subjects at the respective frames in which the plural subjects have been detected and a corresponding imaging unit of the imaging units; if a difference between a range of a specific frame, whose range has been computed, and a range of a frame captured immediately before or after the specific frame, exceeds a predetermined threshold value, adjusting the range of the specific frame such that the difference is reduced; computing a parallax amount that corresponds to the computed range or the adjusted range, based on a predetermined relationship between ranges and parallax amounts; generating a stereoscopic image corresponding to each frame, from plural viewpoint it ages that have been captured by the respective imaging units, based on the computed parallax amount; and recording, at a recording unit, the generated stereoscopic image. The detecting may include determining whether or not a subject that has been detected in a frame immediately before a target frame of detection is detected in the target frame, and the computing of a range or the adjusting of a range may be performed based on a result of the determination.

Yet another aspect of the present invention is a non-transitory, computer-readable storage medium that stores a program that causes a computer to execute imaging processing, the imaging processing including: detecting a subject from respective images of the frames captured by any one of the plural imaging units; if plural subjects are detected, computing a range expressed by a difference between a maximum value and a minimum value of values relating to distances between the respective detected subjects at the respective frames in which the plural subjects have been detected and a corresponding imaging unit of the imaging units; if a difference between a range of a specific frame, whose range has been computed, and a range of a frame captured immediately before or after the specific frame, exceeds a predetermined threshold value, adjusting the range of the specific frame such that the difference is reduced; computing a parallax amount that corresponds to the computed range or the adjusted range, based on a predetermined relationship between ranges and parallax amounts; generating a stereoscopic image corresponding to each frame, from plural viewpoint images that have been captured by the respective imaging units, based on the computed parallax amount; and recording, at a recording unit, the generated stereoscopic image.

The detecting may include determining whether or not a subject that has been detected in a frame immediately before a target frame of detection is detected in the target frame, and the computing of a range or the adjusting of a range may be performed based on a result of the determination.

As described above, in accordance with the above aspects, variations in the parallax amount between frames can be reduced and stereoscopic video images with improved visibility can be obtained, without providing a complex mechanism for adjusting the convergence angle.

### BRIEF DESCRIPTION OF THE DRAWINGS

Exemplary embodiments will be described in detail based on the following figures.

FIG. 1 is a front perspective view of a compound-eye digital camera of the embodiments.

FIG. 2 is a rear perspective view of the compound-eye digital camera of the embodiments.

FIG. 3 is a schematic block diagram illustrating the internal structure of the compound-eye digital camera of the embodiments.

FIG. 4A is a schematic drawing for explaining computing of a subject distance range at the compound-eye digital camera of the embodiments.

FIG. 4B is a schematic drawing for explaining computing of the subject distance range at the compound-eye digital camera of the embodiments.

FIG. 5A is a schematic drawing illustrating the positional relationships between subjects and imaging sections, for explaining parallax amount at the compound-eye digital camera of the embodiments.

FIG. 5B is a schematic drawing illustrating a left image and a right image, for explaining parallax amount at the compound eye digital camera of the embodiments.

FIG. 6 is a schematic drawing illustrating a stereoscopic image, for explaining parallax amount.

FIG. 7 is an example of a graph of the relationship between parallax amount and subject distance range.

FIG. 8 is an example of a table of the relationship between parallax amount and subject distance range.

FIG. 9 is a flowchart of a video image capturing processing routine in a first embodiment.

FIG. 10 is a flowchart of a video image capturing processing routine in a second embodiment.

FIG. 11 is a flowchart of a video image capturing processing routine in a third embodiment.

FIG. 12 is a flowchart of a video image capturing processing routine in a fourth embodiment.

FIG. 13 is a flowchart of a video image capturing processing routine in a fifth embodiment.

FIG. 14 is a perspective view illustrating another example of a compound-eye digital camera of the embodiments.

FIG. 15 is a schematic block diagram illustrating the internal structure of the other example of a compound-eye digital camera of the embodiments.

### DETAILED DESCRIPTION

Exemplary embodiments are described in detail hereinafter with reference to the drawings. Note that the present embodiments describe cases in which the imaging device of the aspect is applied to a compound-eye digital camera that is equipped with a video image capturing mode.

### First Embodiment

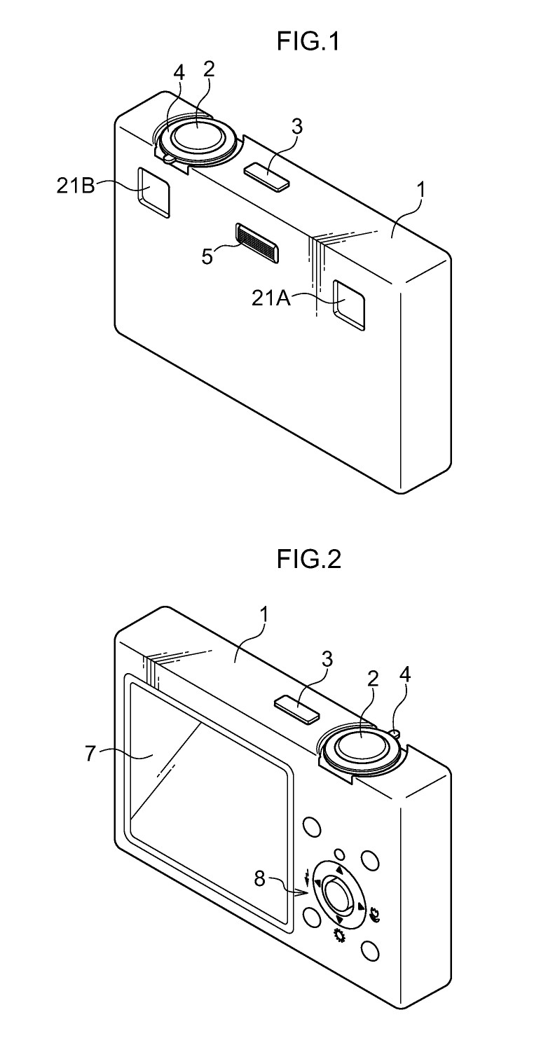

FIG. 1 is a front perspective view of a compound-eye digital camera 1 of a first embodiment, and FIG. 2 is a rear perspective view thereof. As illustrated in FIG. 1, a release button 2, a power button 3, and a zoom lever 4 are provided at the top portion of the compound-eye digital camera 1. A flash 5 and lenses of two imaging sections 21A, 21B are disposed at the front surface of the compound-eye digital camera 1. A liquid crystal monitor 7, that carries out various types of display, and various types of operation buttons 8 are disposed at the rear surface of the compound-eye digital camera 1.

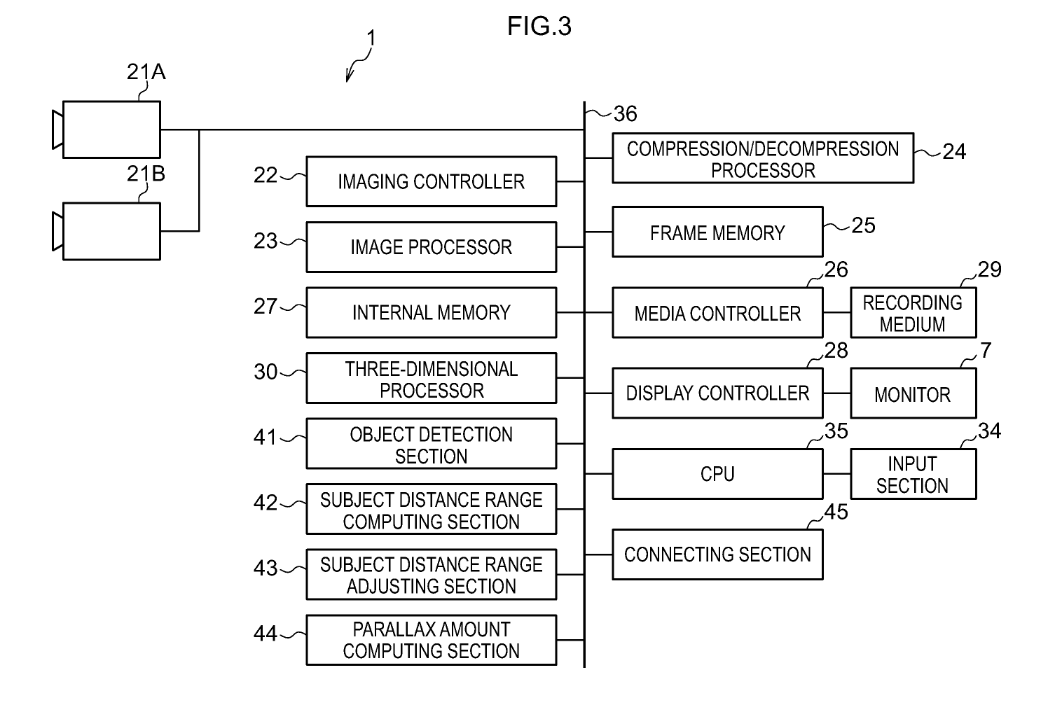

FIG. 3 is a schematic block drawing illustrating the internal structure of the compound-eye digital camera 1. As illustrated in FIG. 3, the compound-eye digital camera 1 is equipped with the two imaging sections 21A, 21B, an imaging controller 22, an image processor 23, a compression/decompression processor 24, a frame memory 25, a media controller 26, an internal memory 27, a display controller 28, a three-dimensional processor 30, an object detection section 41, a subject distance range computing section 42, a subject distance range adjusting section 43, a parallax amount computing section 44, and a connecting section 45. The imaging sections 21A, 21B are disposed so as to have a convergence angle at which the subject is viewed and to have is a predetermined baseline length. The information of the convergence angle and baseline length is stored in the internal memory 27.

The imaging controller 22 includes an unillustrated AF processor and AE processor. In a case in which a static image capturing mode is selected, on the basis of pre-images acquired by the imaging sections 21A, 21B as a result of the release button 2 being push-operated halfway, the AF processor determines the focus region and the focal point positions of the lenses, and outputs them to the imaging sections 21A, 21B. The AE processor determines the diaphragm value and the shutter speed based on the pre-images, and outputs them to the imaging sections 21A, 21B. An instruction for actual imaging, which causes the imaging section 21A to acquire the actual image of the left image and causes the imaging section 21B to acquire the actual image of the right image, is given by full push-operation of the release button 2.

In a case in which a video image capturing mode is selected, the imaging controller 22 instructs the imaging section 21A and the imaging section 21B to continuously carry out processing performed in the above-described static image capturing mode by the push-operation of the release button 2. Note that in both cases of the static image capturing mode and the video image capturing mode, before the release button 2 is operated, the imaging controller 22 instructs the imaging sections 21A, 21B to successively acquire, at a predetermined time interval (e.g., an interval of 1/30 second), through-the-lens images that have fewer pixels than the actual images and are for confirming the imaging range.

The image processor 23 carries out image processings such as white balance adjustment, gradation correction, sharpness correction, and color correction and the like on the digital image data of the left image and the right image that the imaging sections 21A, 21B have acquired.

The compression/decompression processor 24 carries out compression processing in a compression format such as, for example, JPEG or the like, on the image data expressing the left image and the right image that have been subjected to processings by the image processor 23, and generates an image file for stereoscopic viewing. This image file for stereoscopic viewing includes the image data of the left image and the right image, and additional information such as the baseline length, the convergence angle, the imaging date and time and the like, and viewpoint information expressing the viewpoint position, are stored therein in an Exif format or the like.

The frame memory 25 is a work memory that is used for carrying out various types of processings, including the aforementioned processings that the image processor 23 carries out, on the image data expressing the left image and the right image that the imaging sections 21A, 21B acquired.

The media controller 26 carries out control of accessing a recording medium 29 and writing and reading of image files and the like.

The internal memory 27 stores various types of constants that are set at the compound-eye digital camera 1, and programs that the CPU 35 executes.

The display controller 28 displays, on the liquid crystal monitor 7, n stereoscopic image that is generated from the left image and the right image that have been stored in the frame memory 25 at the time of image capturing, and displays, on the liquid crystal monitor 7, the left image and the right image, or a stereoscopic image, which are recorded on the recording medium 29.

In order to stereoscopically display the left image and the right image on the liquid crystal monitor 7, the three-dimensional processor 30 carries out three-dimensional processing on the left image and the right image, and generates a stereoscopic image.

The object detection section 41 detects an appropriate object from the acquired left image or right image. An object is an image expressing an imaging subject that exists in the region that is the object of imaging. An “appropriate” object may be an object at which there is an edge (at which the contour is relatively distinct) in the left image or the right image. Or, corresponding objects may be detected from each of the left image and the right image, and an object whose parallax value is within a predetermined range may be detected as an “appropriate” object.

When detecting an object from an image of the second frame or a frame thereafter, the object detection section 41 detects the object from the current frame by using positional information or the like of the object that has been detected from images of the past frames, and tracking the corresponding object.

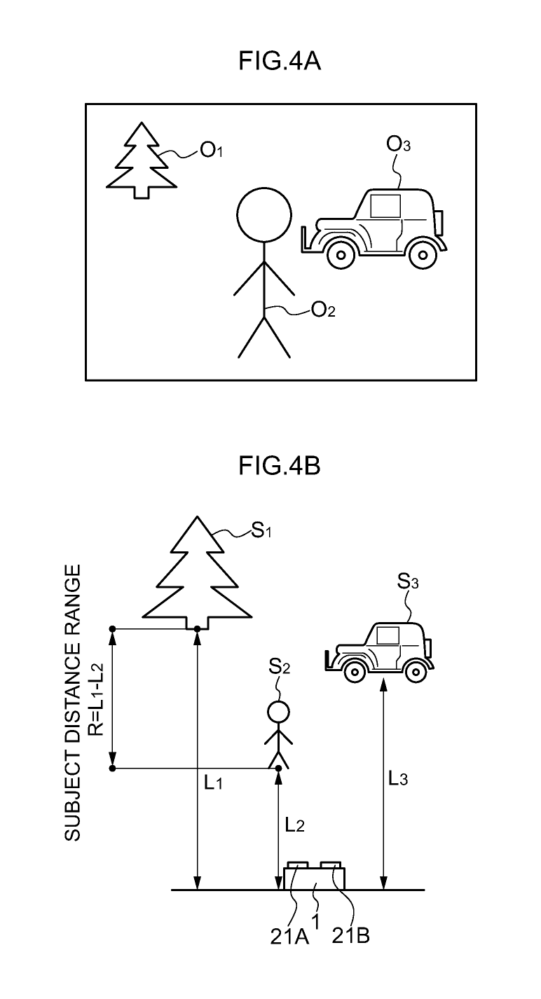

The subject distance range computing section 42 computes, for each object detected from the left image or the right image, the distance between the imaging subject corresponding to the object and the device itself (the imaging section 21A, 21B) using a method such as triangulation or the like, and computes the difference between the maximum value and the minimum value of the distances as a subject distance range. For example, it is assumed that, as illustrated in FIG. 4A, objects O₁, O₂, O₃ are detected from the left image or the right image, and the compound-eye digital camera 1 and imaging subjects S₁, S₂, S₃, that correspond to the objects O₁, O₂, O₃ respectively, have the positional relationships illustrated in FIG. 4B. Given that the distance between the compound-eye digital camera 1 and the subject S₁ is L₁, and the distance between the compound-eye digital camera 1 and the subject S₂ is L₂, and the distance between the compound-eye digital camera 1 and the subject S₃ is L₃, then the maximum value of the distances between the compound-eye digital camera 1 and the subjects is L₁, and the minimum value is L₂ and, therefore, a subject distance range R is computed as R=L₁−L₂.

The subject distance range adjusting section 43 judges whether or not the difference between the subject distance range computed for the image of the previous frame, and the subject distance range computed for the image of the current frame, exceeds a predetermined threshold value. If the difference exceeds the threshold value, the subject distance range adjusting section 43 adjusts the subject distance range of the current frame such that the difference between the subject distance range of the previous frame and the subject distance range of the current frame becomes smaller. As described later, because the parallax amount of each frame is computed on the basis of the subject distance range, large fluctuations in the subject distance range between frames become large fluctuations in the parallax amount between frames. If the parallax amount fluctuates greatly between frames, there become video images that are difficult to view and, therefore, the subject distance range is adjusted such that the fluctuations in the parallax amount do not become large. For example, given that the subject distance range of the current frame is Rm and the subject distance range of the previous frame is Rm−1, a subject distance range Rm′ after adjustment of the current frame may be determined as Rm′=α×Rm+(1−α)×Rm−1 (0<α<1). Note that the method of determining the post-adjustment subject distance range Rm′ of the current frame is not limited to this, and it suffices for there to be an adjustment method that is such that the difference between Rm and Rm−1 becomes smaller, such as addition/subtraction of a predetermined value with respect to Rm.

The parallax amount computing section 44 computes the parallax amount of the current frame from the computed subject distance range or the adjusted subject distance range, based on a predetermined relationship between subject distance ranges and appropriate parallax values corresponding to the subject distance ranges.

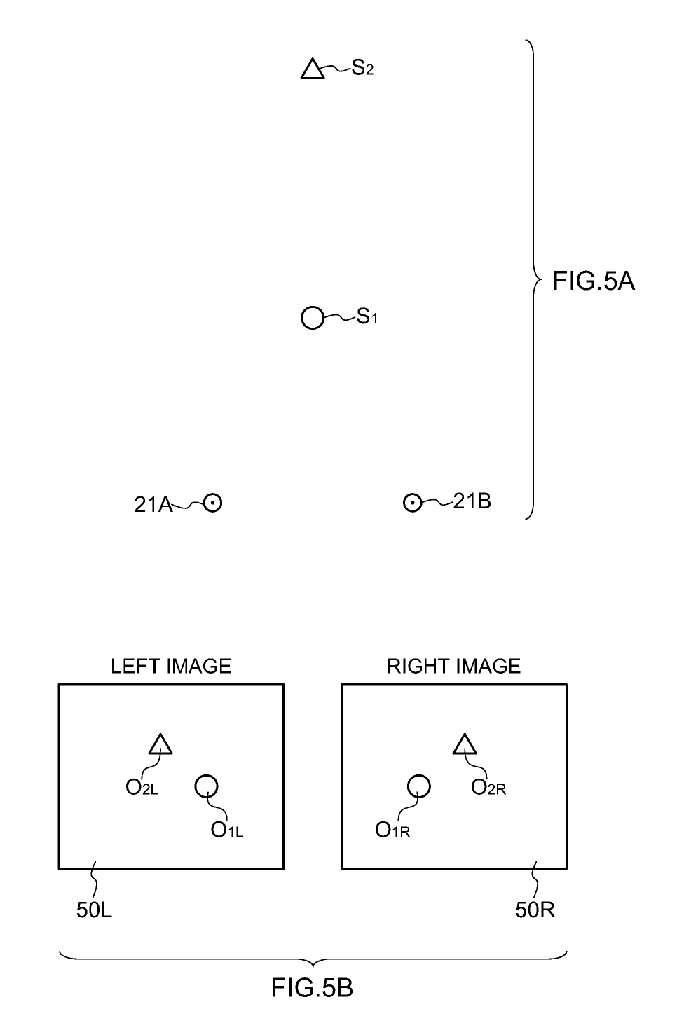

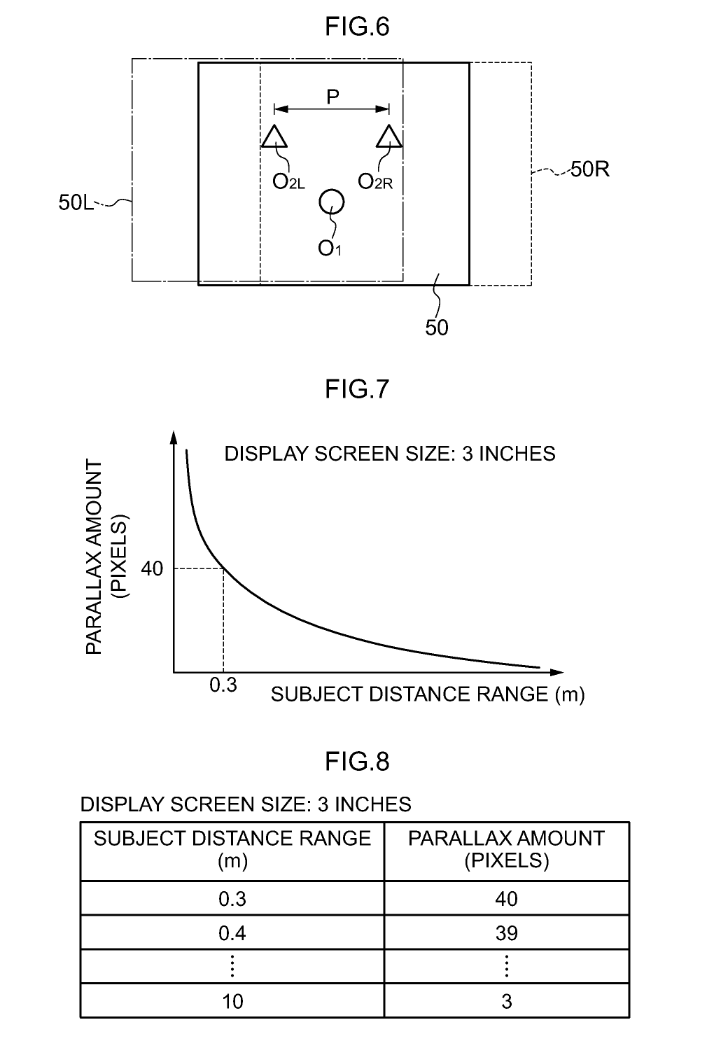

Parallax amount is described here. For example, it is assumed that a subject S₁ and a subject S₂, whose positional relationships with the compound-eye digital camera 1 (the imaging sections 21A and 21B) are those illustrated in FIG. 5A, are captured, and a left image 50L and a right image 50R as illustrated in FIG. 5B are obtained. An object O_{1L} that corresponds to the subject S₁, and an object O_{2L} that corresponds to the subject S₂, are detected from the left image 50L. An object O_{1R} that corresponds to the subject S₁, and an object O_{2R} that corresponds to the subject S₂, are detected from the right image 50R. As illustrated in FIG. 6, a stereoscopic image 50 is formed by superposing the left image 50L and the right image 50R. In FIG. 6, the left image 50L and the right image 50R are superposed such that the object included in the left image 50L and the object O_{1R} included in the right image 50R coincide, i.e., such that object O₁ becomes the crosspoint. The object O_{2L} and the object O_{2R} are offset by distance P. This P is the parallax amount, and, by changing the parallax amount P, the stereoscopic feel of the stereoscopic image can be enhanced or lessened.

The relationship between parallax amount and subject distance range is described next. If the subject distance range is small, the relative parallax between the furthest subject that exists furthest from the compound-eye digital camera 1, and the nearest subject that exists nearest, is small. However, if the subject distance range is large, the relative parallax between the furthest subject and the nearest subject is large. Therefore, in order to obtain a stereoscopic image having an appropriate stereoscopic feel, the parallax amount is increased if the subject distance range is small, and the parallax amount is decreased if the subject distance range is large. On the basis of this relationship, a parallax amount that is suitable for displaying a stereoscopic image on a display screen of a predetermined size is determined in accordance with the subject distance range. For example, as illustrated in FIG. 7, a graph can be made with the subject distance range on the horizontal axis and the parallax amount on the vertical axis, and the relationship between parallax amount and subject distance range may be determined for each size of display screen. Or, as illustrated in FIG. 8, the relationship between parallax amount and subject distance range may be defined in a table, in which the parallax amount in units of pixels and the subject distance range are set in correspondence.

On the basis of a predetermined relationship between parallax amount and subject distance range such as that illustrated in FIG. 7 or FIG. 8, the parallax amount computing section 44 computes a parallax amount that corresponds to the subject distance range computed at the subject distance range computing section 42 or the subject distance range adjusted at the subject distance range adjusting section 43. For example, when using FIG. 7 and FIG. 8, in a case in which the display screen size is 3 inches and the computed or adjusted subject distance range is 0.3 m, the parallax amount is 40 pixels. In the present embodiment, the parallax amount that is computed at the parallax amount computing section 44 is the parallax amount for the object that expresses the nearest subject. Namely, when the left image and right image are superposed as illustrated in FIG. 6, the images are superposed such that the distance between the object that expresses the nearest subject of the left image, and the object that expresses the nearest subject of the right image, is offset by the computed parallax amount.

In a case in which only one object is detected at the object detection section 41, the parallax amount computing section 44 computes the parallax amount by using the detected object as the crosspoint. Further, in a case in which an object is not detected at the object detection section 41, the parallax amount is computed by using a predetermined point determined in advance as the crosspoint.

The connecting section 45 has an interface for connection with a display device. When a display device is connected to the compound-eye digital camera 1 on the basis of control of the CPU 35, the connecting section 45 transmits images that are captured by the imaging sections 21A, 21B, or image data recorded in the internal memory 27 or the recording medium 29, to that display device, and causes images expressed by that image data to be displayed. Note that the compound-eye digital camera 1 and the display device are connected by any communication standard in accordance with the situation, and the method of connection may be wired or may be wireless.

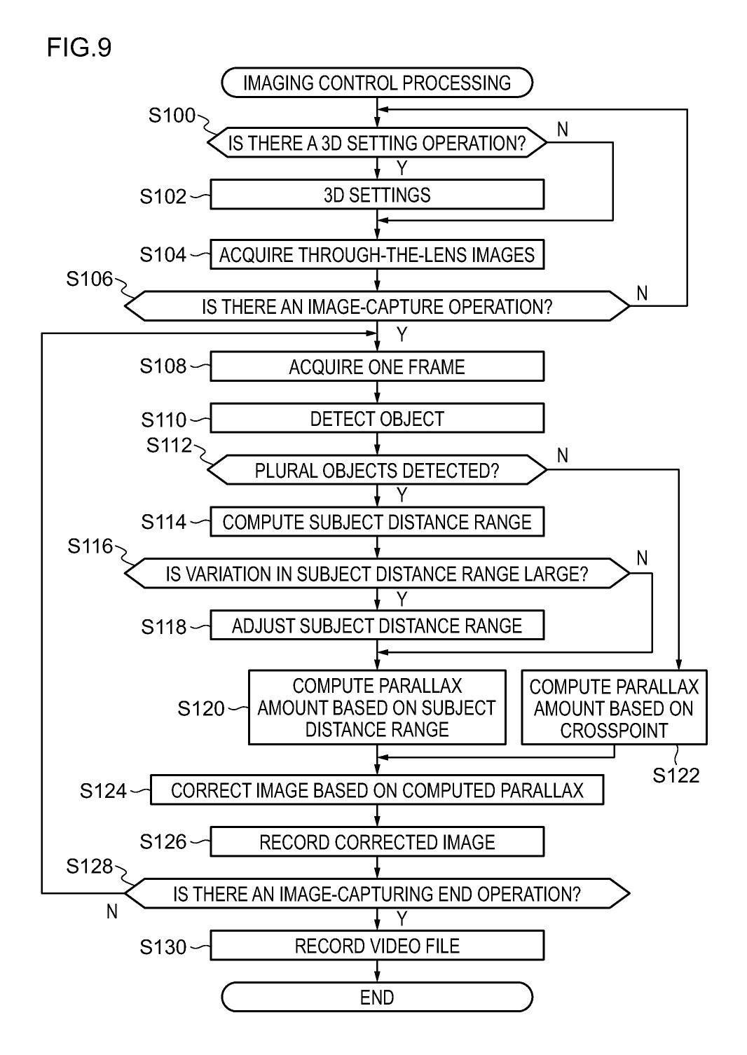

The video image capturing processing routine that is executed at the compound-eye digital camera 1 of the first embodiment is described next with reference to FIG. 9. The present routine starts in response to the operation button 8 being operated by a user and the video image capturing mode being selected.

In step S100, the CPU 35 judges whether or not a 3D setting operation has been performed by a user. The 3D settings include the settings of the display size of the display that is used at the time of display, the recording format of the 3D video images, and the display format of the stereoscopic images such as the 3D strength or the like. Recording formats may be a side-by-side format, a line-by-line format, and the like. The CPU 35 judges that a 3D setting operation has been performed in a case in which a predetermined input operation has been carried out by the user via the input section 34. If it is judged in step S100 that a 3D setting operation has been performed, in step S102, the CPU 35 stores information that expresses the 3D settings corresponding to the setting operation in the internal memory 27. The information that expresses the 3D settings and has been stored here is used for recording a video file in step S130 that is described later.

In step S104, acquisition of through-the-lens images that are captured by the imaging sections 21A and 21B is started.

Next, in step S106, it is judged whether or not an image-capture operation that instructs the start of recording of video images, such as the release button 2 being depressed or the like, has been performed by the user. If it is judged in step S106 that an image-capture operation has not been performed, the CPU 35 moves on to step S100. If it is judged in step S106 that an image-capture operation has been performed, the CPU 35 moves on to step S108. If there is no image-capture operation, the judgment of the present step is repeated until an image-capture operation is detected.

In step S108, the CPU 35 acquires the left image and the right image for one frame, acquired in the state of actual imaging by the imaging sections 21A and 21B. Next, in step S110, the CPU 35 selects one of the left image or the right image that have been acquired in above step S018, and detects one or more appropriate object from the selected image.

Next, in step S112, the CPU 35 judges whether or not plural objects have been detected in step S110. If it is judged in step S112 that plural objects have been detected, the CPU 35 moves on to step S114. If it is judged that only one object has been detected or if it is judged that an object has not been detected, the CPU 35 moves on to step S122.

In step S114, for each object detected from the selected image, the CPU 35 computes the distance between the subject corresponding to the object and the compound-eye digital camera 1 by a method such as triangulation or the like, and computes the difference between the maximum value and minimum value of these distances as the subject distance range.

Next, in step S116, the CPU 35 judges whether or not the variation in the subject distance range between frames is large by judging whether or not the difference between the subject distance range of the current frame computed in step S114, and the subject distance range of the previous frame that has been computed in the same way, exceeds a predetermined threshold value.

If it is judged in step S116 that the variation in the subject distance range between frames is large, the CPU 35 moves on to step S118, and adjusts the subject distance range of the current frame such that the difference between the subject distance range of the previous frame and the subject distance range of the current flame becomes smaller, and moves on to step S120.

If it is judged in step S116 that the variation in the subject distance range between frames is not large, the CPU 35 skips step S118 and moves on to step S120. Also in a case in which the current frame is the first frame and a previous flame does not exist, the judgment in the present step is negative, and the CPU 35 moves on to step S120.

In step 120, on the basis of a predetermined relationship between subject distance ranges and appropriate parallax amounts corresponding to the subject distance ranges such as illustrated in FIG. 7 or FIG. 8, the CPU 35, in a case in which the subject distance range has been adjusted in above step S118, computes the parallax amount of the current frame that corresponds to the adjusted subject distance range, and, in a case in which the subject range has not been adjusted in above step S118, computes the parallax amount of the current frame that corresponds to the subject distance range computed in above step S114. Then, the CPU 35 moves on to step S124.

On the other hand, if it is judged in above step S112 that plural objects have not been detected and the CPU 35 moves on to step S122, the CPU 35 computes the parallax amount on the basis of the crosspoint. Namely, in step S122, in a case in which only one image has been detected, the CPU 35 computes the parallax amount by using that object as the crosspoint, whereas in a case in which an object has not been detected, the CPU 35 computes the parallax amount by using a predetermined point as the crosspoint. Then, the CPU 35 moves on to step 124.

In step S124, the CPU 35 carries out correction on the selected image, on the basis of the parallax amount computed in step S122. For example, a method of parallel-translating each pixel in the left-right direction by a distance corresponding to the parallax amount may be used as the correction method. Note that, in step S124, correction may be carried out on the image that has not selected in step S110 (hereinafter also referred to as “non-selected image”). In a case of correcting the non-selected image, the non-selected image is parallel-translated in the opposite direction of the case of correcting the selected image. Alternatively, both the selected image and the non-selected image may be corrected. In a case of correcting both the selected image and the non-selected image, each of the selected image and the non-selected image is parallel-translated in mutually opposing directions of the left-right direction, by ½ of the distance corresponding to the parallax amount. Moreover, at the time of carrying out correction, regions of the left image and the right image (i.e., regions at end portions of the image), where regions that correspond to one another no longer exist due to the aforementioned parallel translation in the left-right direction, are trimmed as needed.

Then, in step S126, the CPU 35 records the image that has been corrected in step S124 in the internal memory 27. In this way, images corrected in accordance with variation in the subject distance range so as to have the optimal parallax amount, are respectively recorded, and a video file corrected to the optimal parallax amount is transmitted to the display device. As a result, optimal 3D video images can be played-back while the burden of correcting the images is reduced at the display device side. Note that, at the time of recording the corrected images, the parallax amount computed in step S122 may be recorded in association therewith.

In step S128, the CPU 35 judges whether or not an image-capturing end operation that instructs the stopping of recording of video images, such as the release button 2 being depressed again or the like, has been performed. If it is judged in step S128 that there is no image-capturing end operation, the CPU 35 returns to step S108, and acquires the next frame and repeats the processings of steps S108 through S126. If it is judged in step S128 that an image-capturing end operation has been performed, the CPU 35 moves on to step S130 where the CPU 35 generates stereoscopic images corresponding to the respective frames from the data of the left image and the right image per frame of the number of frames captured by the imaging sections 21A and 21B (the corrected image in a case in which the image has been corrected in step S124) and the parallax amounts, makes the stereoscopic images into one file, records the file on the recording medium 29 as a video file to which header information is added, and ends processing.

At this time, the CPU 35 records the video file obtained by generating stereoscopic images in a format adapted to the stereoscopic image display format that corresponds to the 3D settings that have been set in step S102. For example, the pixel size in the video file is changed in accordance with the display size that is set, or information expressing the offset amounts of the left and right images in accordance with the 3D strength that is set is added to the video file. Further, the video file is recorded in accordance with the recording format of the 3D video images. For example, in a case which the side-by-side format is set, two images are recorded as one frame in a state of being lined-up in the left-right direction. In a case in which the line-by-line format is set, images are recorded after the colors of the respective left and right images are converted, and then the respective images are converted so as to be cut-out in strip shapes are lined-up alternately. In this way, the video file can be recorded at the arbitrary 3D settings that the user desires by carrying out the 3D settings on the basis of the information inputted by user operation in step S102, and recording the video file on the basis of these 3D settings.

As described above, the composite-eye digital camera of the first embodiment computes a subject distance range for each frame. If the difference between the computed subject distance range of the current frame and subject distance range of the previous frame is large, the subject distance range of the current frame is adjusted such that the difference between the subject distance range of the previous frame and the subject distance range of the current frame becomes smaller, and an appropriate parallax amount is computed from the subject distance range. Therefore, variations in parallax amount between frames are reduced and stereoscopic video images with improved visibility can be obtained, without providing a complex mechanism for adjusting the convergence angle.

Note that the time at which the processings of steps S124 and S126 are carried out is not limited to the time immediately after the computing of the parallax amount in step S122, and may be the time of storing the video file at the end of image capturing in step S130. In this case, correction may be carried out on all of the frames at the time of storing the video file, and, in the same way as in step S130, a video file may be generated and recorded from the respective images so as to be in a stereoscopic image display format that corresponds to the 3D settings set in step S102.

### Second Embodiment

A second embodiment is described next. In the second embodiment, description is given of a case in which, if the object used in computing the subject distance range of the previous frame is not detected from the current frame, the difference between the subject distance range of the previous frame and the subject distance range of the current frame is considered to be large, and the subject distance range of the current frame is adjusted. Since the structure of the compound-eye digital camera of the second embodiment is similar to the structure of the compound-eye digital camera 1 of the first embodiment, the same reference numerals are used and description thereof is omitted.

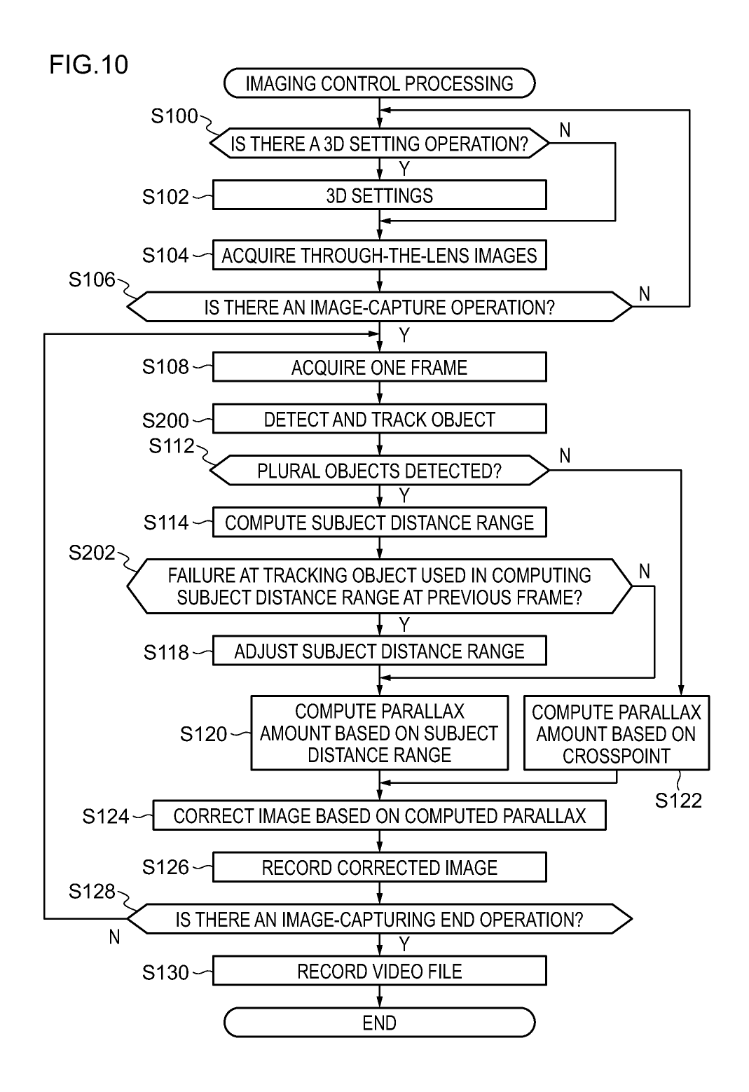

The video image capturing processing routine that is executed at the compound-eye digital camera 1 of the second embodiment is described with reference to FIG. 10. The present routine starts in response to the operation button 8 being operated by the user and the video image capturing mode being selected. Note that processings that are the same as those of the video image capturing processing of the first embodiment are denoted by the same reference numerals, and detailed description thereof is omitted.

Staring from step S100 and at step S108, the CPU 35 acquires the left image and the right image for one frame. Next, in step S200, the CPU 35 detects an appropriate object from the left image or the right image acquired in step S108. Further, the CPU 35 tracks an object detected from the left image or the right image of the previous frame, in the left image or the right image of the current frame by using positional information of the object or the like.

Next, in step S112, if it is judged that plural objects has been detected in above step S200, the CPU 35 moves on to step S114 and computes, as the subject distance range, the difference between the maximum value and the minimum value of the distances between the subjects corresponding to the objects and the compound-eye digital camera 1.

Next, in step S202, on the basis of the results of tracking the object in step S200, the CPU 35 judges whether or not tracking of the object used in computing the subject distance range at the previous frame, has failed. In a case in which the object detected from the previous frame is not detected from the current frame due to the object moving out-of-frame or the object being occluded by another object or the like, it is judged that tracking of the object has failed. In a case in which it is judged in step S202 that tracking of the object used in computing the subject distance range at the previous frame has failed, there is the strong possibility that the subject distance range computed in step S114 is fluctuating greatly with respect to the subject distance range computed for the previous frame. Thus, if tracking of the object used in computing the subject distance range of the previous flame fails, the CPU 35 moves on to step S118 and adjusts the subject distance range of the current frame such that the difference between the subject distance range of the previous frame and the subject distance range of the current frame becomes smaller. On the other hand, if the tracking of the object used in computing the subject distance range of the previous frame has not failed, the CPU 35 skips step S118 and moves on to step S120 without adjusting the subject distance range, and computes the parallax amount from the subject distance range.

From there on, in the same way as in the first embodiment, the CPU 35 executes the processings of step S120 to step S130, and ends the processing.

As described above, if tracking of the object used in computing the subject distance range of the previous frame fails, the compound-eye digital camera of the second embodiment considers that the difference between the subject distance range of the current frame and the subject distance range of the previous frame is large, and may adjust the subject distance range of the current frame such that the difference between the subject distance range of the previous frame and the subject distance range of the current frame becomes smaller.

### Third Embodiment

A third embodiment is described next. In the third embodiment, description is given of a case in which objects whose amounts of movement are large are excluded so as to not be used in computing the subject distance range. Since the structure of the compound-eye digital camera of the third embodiment is similar to the structure of the compound-eye digital camera 1 of the first embodiment, the same reference numerals are used and description thereof is omitted.

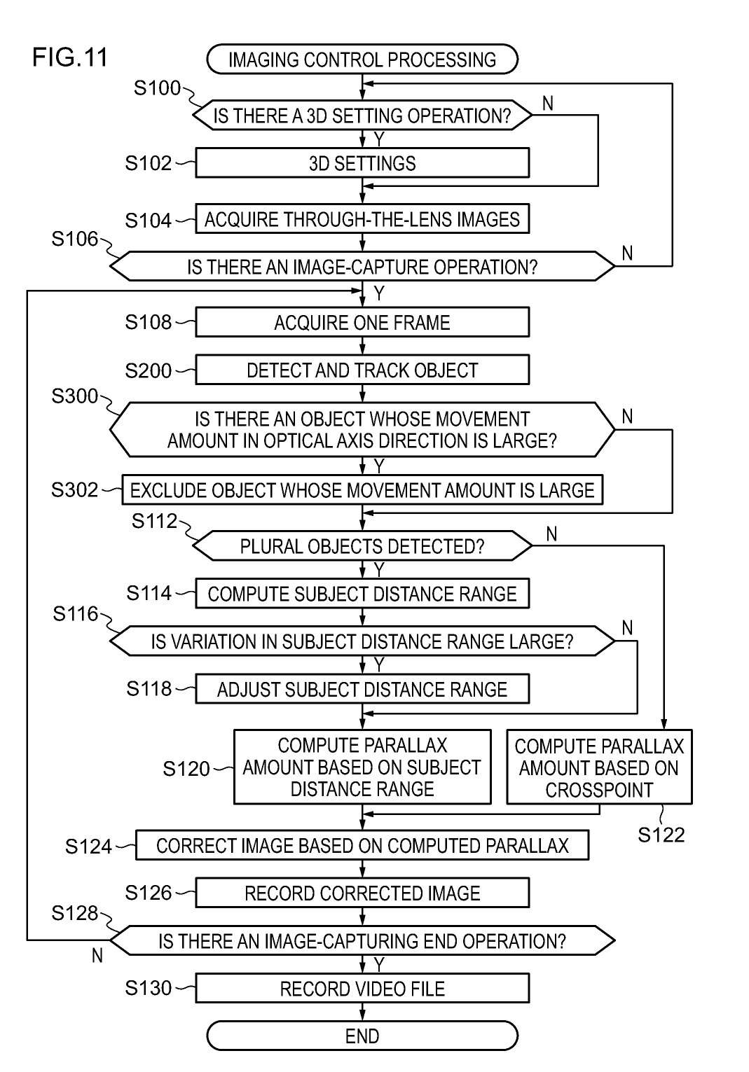

The video image capturing processing routine that is executed at the compound-eye digital camera 1 of the third embodiment is described with reference to FIG. 11. The present routine starts in response to the operation button 8 being operated by the user and the video image capturing mode being selected. Note that processings that are the same as those of the video image capturing processings of the first and second embodiments are denoted by the same reference numerals, and detailed description thereof is omitted.

Starting from step S100 and at step S108, the CPU 35 acquires the left image and the right image for one frame. Next, in step S200, the CPU 35 detects an appropriate object from the left image or the right image that has been acquired in step S108. Further, the CPU 35 tracks an object detected from the left image or the right image of the previous frame, in the left image or the right image of the current frame by using positional information of the object or the like.

Next, in step S300, on the basis of the results of tracking the object of step S200, the CPU 35 judges whether or not the direction of movement of the tracked object is along the optical axis direction of the imaging section. If the image that is used in the detection and tracking of the object is the left image, the optical axis direction of the imaging section is the optical axis direction of the imaging section 21A, and if it is the right image, the optical axis direction is the optical axis direction of the imaging section 21B. The CPU 35 computes the amount of movement between frames for an object whose direction of movement is the optical axis direction, and, by comparing this amount of movement with a predetermined amount of movement that is determined in advance, judges whether or not an object whose amount of movement is large exists. If it is judged in step S300 that an object whose amount of movement is large exists, the CPU 35 moves on to step S302 and excludes the object whose amount of movement is large from the objects that have been detected and tracked in above step S200, and moves on to step S112. Since the speed of movement of a subject that corresponds to an object with large amount of movement is rapid, the distance between the subject and the compound-eye digital camera 1 fluctuates greatly between frames. When an object that expresses such a subject is used in computing the subject distance range, the subject distance range fluctuates greatly and, therefore, such an object is excluded so as to not be used in computing the subject distance range.

On the other hand, if is judged in step S300 that an object whose amount of movement of large does not exist, the CPU 35 skips step S302 and moves on to step S112. In step S112, the CPU 35 judges whether or not plural objects have been detected other than the object that has been excluded in step S302, and, from there on, in the same way as in the first embodiment, executes the processings of step S114 through step S130, and ends the processing.

As described above, the compound-eye digital camera of the third embodiment excludes in advance an object, whose amount of movement is large and for which there is a strong possibility of leading to a large fluctuation in the subject distance range between frames, from objects used in computing the subject distance range. Due thereto, fluctuations in the subject distance range between frames can be reduced.

### Fourth Embodiment

A fourth embodiment is described next. In the fourth embodiment, description is given of a case in which objects that a user is particularly interested are selected and registered in advance. Since the structure of the compound-eye digital camera of the fourth embodiment is similar to the structure of the compound-eye digital camera 1 of the first embodiment, the same reference numerals are used and description thereof is omitted.

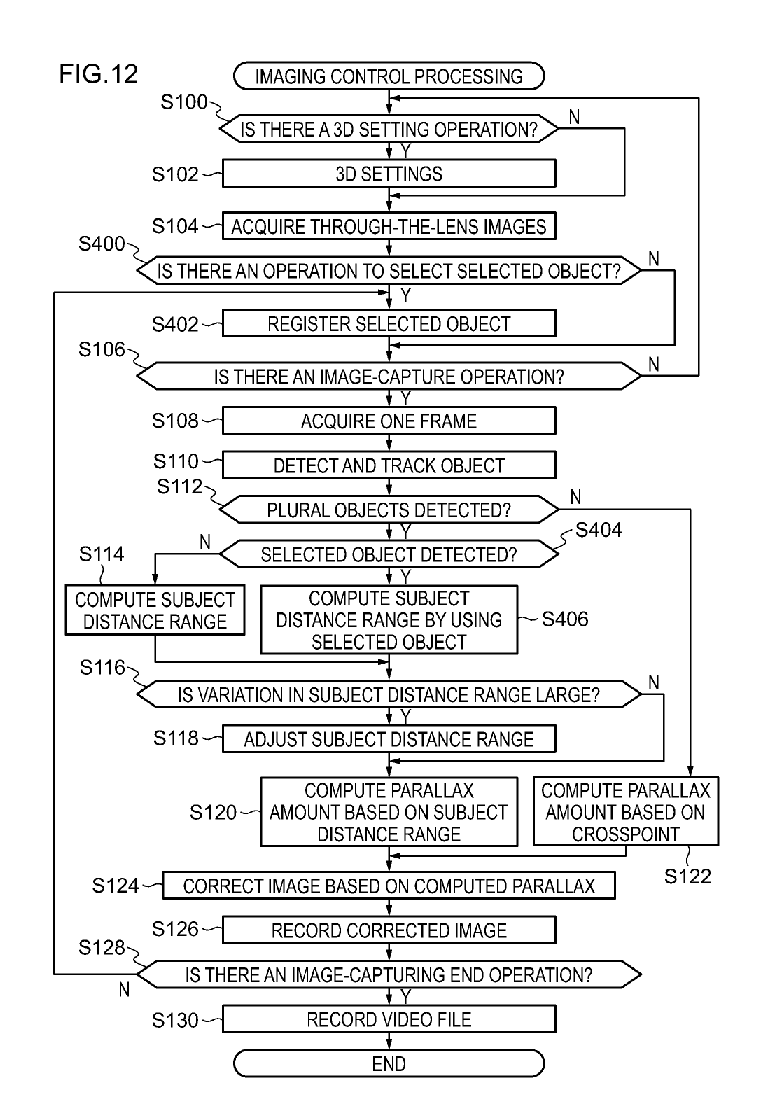

The video image capturing processing routine that is executed at the compound-eye digital camera 1 of the e fourth embodiment is described with reference to FIG. 12. The present routine starts in response to the operation button 8 being operated by the user and the video image capturing mode being selected. Note that processings that are the same as those of the video image capturing processing of the first embodiment are denoted by the same reference numerals, and detailed description thereof is omitted.

After step S100 through step S102, the CPU 35 acquires through-the-lens images in step S104. Next, in step S400, the CPU 35 judges whether or not the user has performed the operation of selecting an object of particular interest (hereinafter referred to as “selected object”). A selected object can be selected by, for example, operating the operation button 8 to move the cursor on the image displayed on the liquid crystal monitor 7, and depressing the select button on that object.

Next, in step S402, the CPU 35 extracts information such as the contour or characteristic amount or the like of the selected object selected in step S400, and registers the information in a predetermined storage area. Plural selected objects may be registered.

Next, after step S106 to step S112, if it judged in step S112 that plural objects have been detected, the CPU 35 moves on to step S404 and compares detected objects and the information of the selected objects registered in step S402, and judges whether or not a selected object is included among the detected objects. If it is judged in step S404 that a selected object is included, the CPU 35 moves on to step S406. If it is judged in step S404 that a selected object is not included, the CPU 35 moves on to step S114.

In step S406, the CPU 35 computes the subject distance range by using the selected object. In a case in which plural selected objects are registered and plural selected objects have been detected, the difference between the maximum value and the minimum value of the distances between the compound-eye digital camera 1 and the subjects corresponding to the respective selected objects that have been detected can be computed as the subject distance range. If only one selected object is included among the detected plural objects, the subject distance range is computed by using the selected object and one object other than the selected object. An object at which the distance between the subject expressed by the object and the compound-eye digital camera 1 is a maximum or a minimum, or an object that corresponds to a subject at which the distance between that subject and the subject that expresses the selected object is a maximum or a minimum, or the like can be used as the object other than the selected object.

From there on, in the same way as in the first embodiment, the CPU 35 executes the processings of step S116 through step S130, and ends the processing. If the detected object is only one selected object, the judgment in step S112 is negative and the CPU 35 moves on to step S122 and computes the parallax amount by taking the selected object as the crosspoint.

As described above, in accordance with the compound-eye digital camera of the fourth embodiment, the subject distance range is computed by using an object of particular interest, and the subject distance range is adjusted such that fluctuations in the subject distance range between frames do not become large. As a result, stereoscopic video images that are easy to view, when viewed with particular attention to a specific object, can be obtained.

### Fifth Embodiment

A fifth embodiment is described next. In the fifth embodiment, description is given of a case in which, when a display device is connected to the compound-eye digital camera 1, information expressing the stereoscopic image display format of that display device is inputted, and a video file is created and recorded based on this information. Note that, because the structure of the compound-eye digital camera of the fifth embodiment is similar to the structure of the compound-eye digital camera 1 of the first embodiment, the same reference numerals are used and description thereof is omitted.

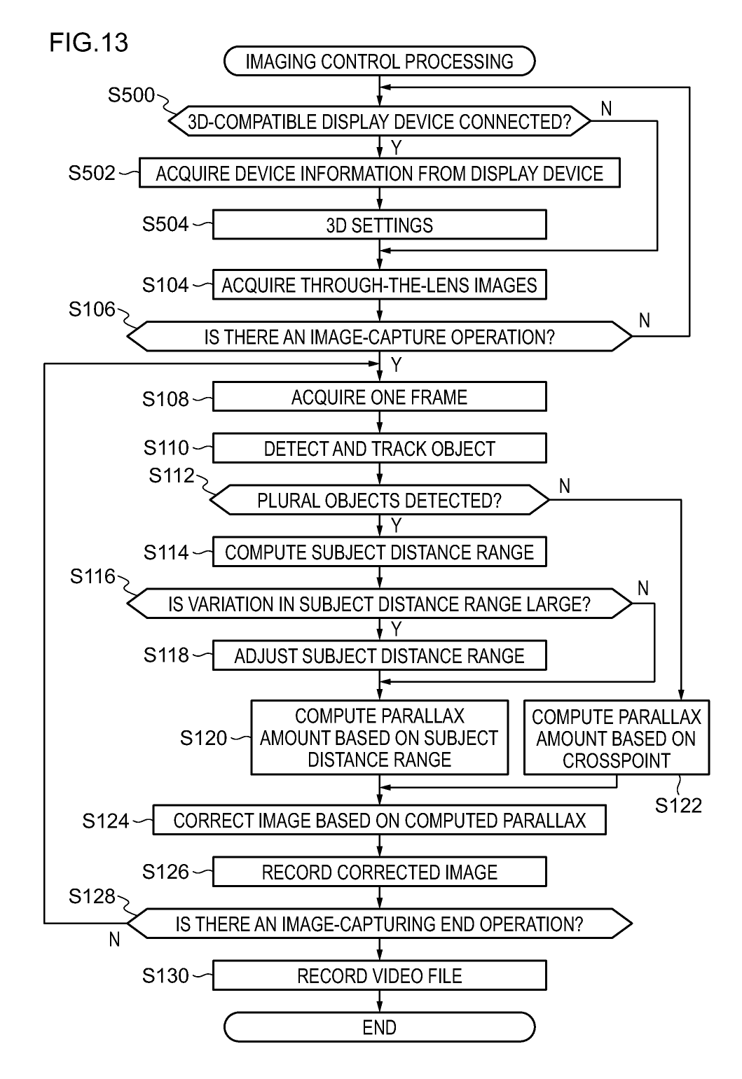

The video image capturing processing routine that is executed at the compound-eye digital camera 1 of the fifth embodiment is described with reference to FIG. 13. The present routine starts in response to the operation button 8 being operated by the user and the video image capturing mode being selected. Note that processings that are the same as those of the video image capturing processing of the first embodiment are denoted by the same reference numerals, and detailed description thereof is omitted.

In step S500, the CPU 35 judges whether or not a 3D-compatible display device is connected to the compound-eye digital camera 1. If a 3D-compatible display device is connected, the CPU 35 moves on to step S502, and if a 3D-compatible display device is not connected, the CPU moves on to step S104. In step S502, the CPU 35 acquires device information from the connected display device. This device information includes information relating to 3D settings. Information relating to 3D settings includes the display size of the display that is used at the time of display, the recording format of 3D video images that can be displayed, and 3D strength that can be set, and the like. In step S504, the CPU 35 stores information expressing the 3D settings in the internal memory 27 in accordance with the device information acquired in step S502.

After step S104 through step S128, in step S130, the CPU 35 generates stereoscopic images corresponding to the respective frames from the data of the left image and the right image per frame of the number of captured frames and the parallax amounts, makes the stereoscopic images into one file, records the file on the recording medium 29 as a video file to which header information is added, and ends processing. At this time, the CPU 35 records the video file obtained by generating stereoscopic images in a format adapted to a stereoscopic image display format that corresponds to the 3D settings that have been set in step S504. In this way, in step S504, 3D settings are carried out on the basis of the information inputted from the display device, and a video file is recorded on the basis of these 3D settings. As a result, a video file can be recorded according to 3D settings that are optimal for a display device by merely connecting the display device to the composite-eye digital camera 1.

Note that the processings of steps S500 through S504 of the above-described fifth embodiment may be replaced with steps S100 and S102 of the first through fourth embodiments, and a video file may be recorded at step S130 in a stereoscopic image display format that corresponds to the 3D settings set in step S504.

In the above-described first through fifth embodiments, description is given of cases in which the distance between each subject and the imaging unit is computed as the value that relates to the distance between the subject and the imaging unit, and the subject distance range that is expressed by the difference between the maximum value and the minimum value of these distances is computed. However, embodiments are not limited to this, and the parallax of each subject may be computed as the value relating to the distance between the subject and the imaging unit, and a parallax range that is expressed by the difference between the maximum value and the minimum value of the parallaxes, may be computed. In this case, a parallax range computing section and a parallax range adjusting section may be provided instead of the subject distance range computing section 42 and the subject distance range adjusting section 43 illustrated in FIG. 3.

The parallax range computing section generates a parallax map, determines the parallax of each object detected at the object detection section 41, and computes the parallax range from the difference between the maximum value and the minimum value of the parallaxes. If a selected object is registered, the parallax range is computed by using the parallax of the selected object. In generating a parallax map, first, stereo matching is carried out with respect to the left image and the right image, and, by using the left image as the reference for example, a pixel (x2, y2) on the right image that corresponds to a pixel (x1, y1) on the left image is extracted. Parallax d between the pixel (x1, y1) on the left image and the corresponding pixel (x2, y2) on the right image can be calculated as d=x2−x1. The parallax map is generated by storing this parallax d for the pixel position (x1, y1) of the left image that is the reference. Then, detected objects and the parallax map are compared, and the parallax that is stored at the pixel position on the parallax map that corresponds to the position of an object is determined as the parallax of that object. In a case in which different parallaxes are stored at plural pixel positions within the region corresponding to the position of an object, the mean or the mode or the like of the parallaxes within that region may be determined as the parallax of that object.

By processings that are similar to those of the processings at the subject distance range adjusting section 43, the parallax range adjusting section judges whether or not the difference between the parallax range computed for the image of the previous frame, and the parallax range computed for the image of the current frame, exceeds a predetermined threshold value. If the difference exceeds the threshold value, the parallax range adjusting section adjusts the parallax range of the current frame such that the difference between the parallax range of the previous frame and the parallax range of the current frame becomes smaller.

The parallax amount computing section 44 computes the parallax amount of the current frame from the computed parallax range or the adjusted parallax range based on a predetermined relationship between parallax ranges and appropriate parallax amounts corresponding to the parallax ranges. As described above, the relationship between parallax amount and subject distance range is such that, if the subject distance range is small, the relative parallax between a farthest subject that is furthest from the compound-eye digital camera 1 and the nearest subject that is nearest thereto is small, and if the subject distance range is large, the relative parallax between the farthest subject and the nearest subject is large. Thus, in order to obtain stereoscopic images having an appropriate stereoscopic feel, the parallax amount is increased if the subject distance range is small, and the parallax amount is reduced if the subject distance range is large. Here, if the subject distance range is small, the parallax range also is small, and, if the subject distance is large, the parallax range also is large. Accordingly, the relationship between parallax range and parallax amount can be determined similarly to the relationship between subject distance range and parallax amount. For example, in a case in which the relationship between parallax range and parallax amount is determined as a graph such as illustrated in FIG. 7, it suffices to set the parallax range (pixels) on the horizontal axis.

Further, the above-described first through fifth embodiments may be combined as needed. In a case in which the third embodiment and the fourth embodiment are combined, it may be configured such that that object whose amount of movement is large is not excluded if that object is a selected object. Or, it may be configured such that object whose amount of movement is large is excluded even if that object is a selected object.

Further, the above embodiments describe cases in which it is judged whether or not the difference between the subject distance range of the previous frame and the subject distance range of the current frame is large, and the subject distance range of the current frame is adjusted. However, configuration may be made such that images of a predetermined number of frames are acquired, and, after the subject distance range of each frame is computed, judgment is made as to whether or not adjustment of the subject distance range of a specific frame is necessary, by comparing the subject distance range of the specific frame with the subject distance range of the frame captured immediately after that specific frame.

Further, although the above embodiments describe cases of determining the parallax amount of the nearest subject, in a case in which selected objects are selected as in the fourth embodiment, the parallax amount of a selected object may be determined.

Further, although the present embodiments describe a compound-eye digital camera of a structure equipped with two imaging sections, the embodiments may be applied similarly also to cases of acquiring three or more images in a structure that is equipped with three or more imaging sections. In this case, it suffices to carry out processings that are similar to those of the above-described embodiments by combining any two images from among the plural images.

The respective blocks illustrated in FIG. 3 may be configured by hardware, or the functions of the respective blocks may be realized by software, or may be configured by combinations of hardware and software. In the case of the configuration by software, the video image capturing processing routine of the present embodiment may be implemented by a program and the program may be executed by a CPU. The program may be provided by being stored in a storage medium, or may be provided by being stored in a storage device such as a server or the like and downloaded via a network.

A digital camera has been described above as an embodiment of the imaging device of but the configuration of the imaging device is not limited to this. Other embodiments may include, for example, a camera for a PC that is incorporated therein or is externally attached thereto, or a portable terminal device having an imaging function such as described hereinafter.

Examples of embodiments of portable terminal devices include a cell phone, a smart phone, a PDA (Personal Digital Assistant), and a portable game device. Detailed description is given hereinafter with reference to the drawings by using a smart phone as an example.

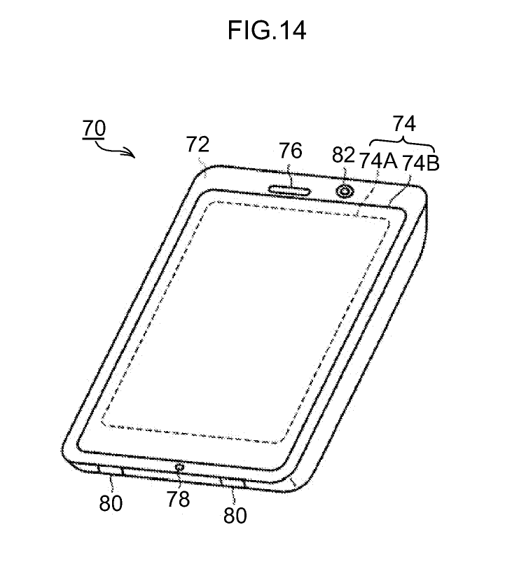

FIG. 14 is a drawing illustrating the exterior of a smart phone 70 according to an embodiment. The smart phone 70 illustrated in FIG. 14 has a housing 72 that is flat-plate-shaped, and a display/input section 74 on one surface of the housing 72, which integrally includes a display panel 74A that serves as a display section and an operation panel 74B that serves as an input section, The housing 72 has a speaker 76, a microphone 78, an operation section 80, and a camera section 82. Note that the structure of the housing 72 is not limited to this, and for example, may employ a configuration in which the display section and the input section are independent, or may employ a configuration that has a fold-up structure or a sliding mechanism.

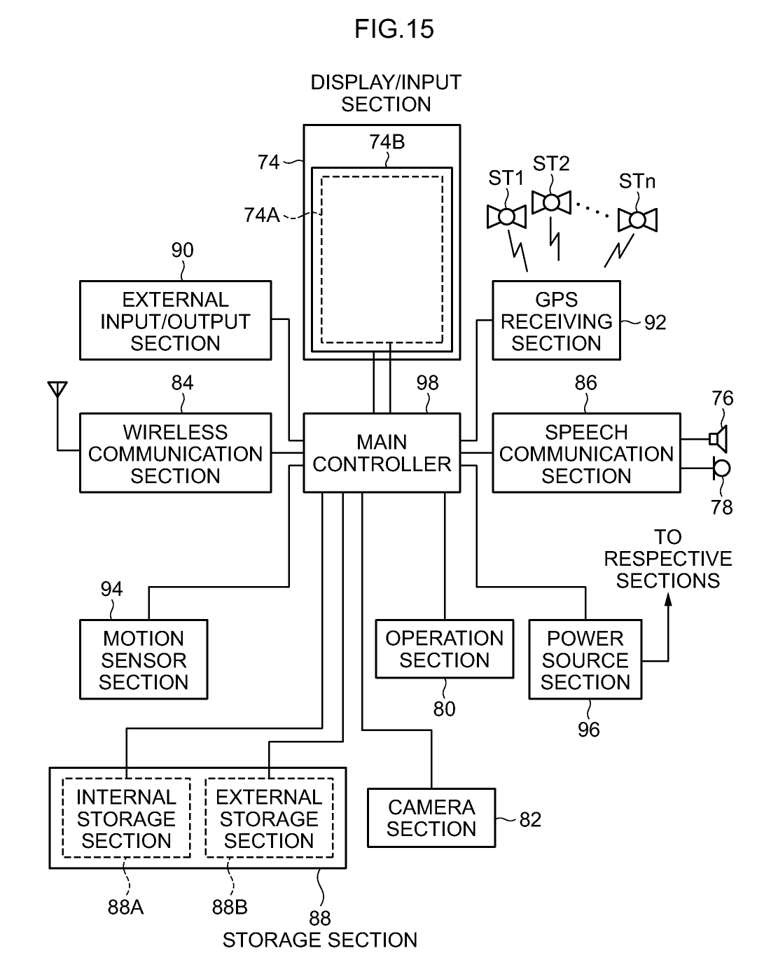

FIG. 15 is a block diagram illustrating the configuration of the smart phone 70 illustrated in FIG. 14. As illustrated in FIG. 15, the smart phone 70 includes, as main components, a wireless communication section 84, the display/input section 74, a speech communication section 86, the operation section 80, the camera section 82, a storage section 88, an external input/output section 90, a Global Positioning System (GPS) receiving section 92, a motion sensor section 94, a power source section 96, and a main controller 98. Further, the smart phone 70 includes, as a main function, a wireless communication function that carries out mobile wireless communication via a base station device BS and a mobile communication network NW.

The wireless communication section 84 carries out wireless communication with the base station device BS that is accommodated in the mobile communication network NW, in accordance with instructions of the main controller 98. The transmission/reception of various types of file data such as voice data and image data and the like, email data, and the like, and the reception of Web data and streaming data and the like are carried out using such wireless communication.

The display/input section 74 is a touch panel that displays images (still images and video images) and character information and the like so as to visually transfer information to the user and detects user operation with respect to the displayed information, and includes the display panel 74A and the operation panel 74B.

The display panel 74A uses an LCD (Liquid Crystal Display), an OELD (Organic Electro-Luminescence Display) or the like as a display device. The operation panel 74B is a device that is placed on display surface of the display panel 74A such that the displayed images can be seen, and detects one or more coordinates that are operated by the finger of a user or a stylus. In response to this device being operated by the finger of a user or a stylus, a detection signal generated due to the operation is outputted to the main controller 98. Then, the main controller 98 detects the operation position (coordinates) on the display panel 74A based on the received detection signal.

As illustrated in FIG. 14, the display panel 74A and the operation panel 74B of the smart phone 70 of the embodiment are made integral to structure the display/input section 74, and the operation panel 74B is disposed so as to completely cover the display panel 74A. In cases of employing such an arrangement, the operation panel 74B may be provided with a function that detects user operation also at a region outside of the display panel 74A. In other words, the operation panel 74B may be provided with a detection region (hereinafter called display region) for the superposed portion that is superposed on the display panel 74A, and a detection region (hereinafter called non-display region) for the outer edge portion other than the display region that is not superposed on the display panel 74A.

The size of the display region and the size of the display panel 74A may be made to completely coincide, but the both do not absolutely have to be made to coincide. Further, the operation panel 74B may be provided with two sensitive regions that are an outer edge portion and an inner side portion other than the outer edge portion. The width of the outer edge portion may be designed appropriately in accordance with the size of the housing 72. Examples of the position detecting method that is employed at the operation panel 74B include a matrix switch method, a resistance film method, a surface elastic wave method, an infrared method, an electromagnetic induction method, an electrostatic capacitance method or the like, and any method may be employed.

The speech communication section 86 has the speaker 76 and the microphone 78. The speech communication section 86 converts the voice of the user inputted through the microphone 78 into voice data that can be processed at the main controller 98, outputs the voice data to the main controller 98, decodes voice data received from the wireless communication section 84 or the external input/output section 90, and outputs the decoded data from the speaker 76. Further, as illustrated in FIG. 14, the speaker 76 may be disposed on the same surface as the surface at which the display/input section 74 is provided, and the microphone 78 may be disposed at a side surface of the housing 72.

The operation section 80 is a hardware key that uses a key switch or the like, and receives an instruction from the user. For example, as illustrated in FIG. 14, the operation section 80 may be a push-button-type switch that is disposed at a side surface of the housing 72 of the smart phone 70, which is turned on when depressed by a finger or the like, is turned off state due to the restoring force of a spring or the like when the finger is moved away.

The storage section 88 stores control programs and control data of the main controller 98, application software, address data that associates the names of communication partners with their phone numbers and the like, data of malls that have been sent and received, Web data downloaded by Web browsing, and downloaded content data, and temporarily stores streaming data and the like. Further, the storage section 88 is configured by an internal storage section 88A that is incorporated within the smart phone, and an external storage section 88B that has an external memory slot and can be attached and removed freely. Note that each of the internal storage section 88A and external storage section 88B that configure the storage section 88 is realized by a storage medium such as a flash memory type, a hard disk type, a multimedia card micro type, or a card type memory (e.g., a MicroSD® memory or the like), a RAM (Random Access Memory), a ROM (Read Only Memory), or the like.

The external input/output section 90 serves as an interface with all external devices that are to be connected to the smart phone 70, and is for direct or indirect connection with other external devices by communication (e.g., a universal serial bus (USB), IEEE 1394, or the like) or via a network (e.g., the internet, a wireless LAN, Bluetooth®, RFID (Radio Frequency Identification), infrared communication (Infrared Data Association: IrDA®), UWB® (Ultra Wideband) (registered trademark), ZigBee® or the like).

Examples for external devices to be connected to the smart phone 70 include wired/wireless headsets, wired/wireless external chargers, wired/wireless data ports, memory cards and SIM (Subscriber Identity Module Card)/UIM (User Identity Module Card) cards that are connected via a card socket, external audio/video devices that are connected via an audio/video I/O (Input/Output) terminal, external audio/video devices that are wirelessly connected, smart phones that are connected by wire/wirelessly, personal computers that are connected by wire/wirelessly, PDAs that are connected by wire/wirelessly, personal computers that are connected by wire/wirelessly, earphones, and the like. The external input/output section 90 can transfer data received from such external devices to the respective structural components at the interior of the smart phone 70, and can transfer data of the interior of the smart phone 70 to external devices.

The UPS receiving section 92 receives, in accordance with instructions of the main cont oiler 98, GPS signals that are transmitted from GPS satellites ST1 through STn, executes positioning computing processing that is based on the received, plural GPS signals, and detects the position of the smart phone 70, which is formed from the latitude, longitude and altitude. When position information can be acquired from the wireless communication section 84 or the external input/output section 90 (e.g., a wireless LAN), the GPS receiving section 92 may detect the position by using that position information.

The motion sensor section 94 has, for example, a triaxial acceleration sensor, and detects physical motion of the smart phone 70 in accordance with instructions of the main controller 98. The direction of movement and the acceleration of the smart phone 70 are detected as a result of the motion sensor section 94 detecting physical motion of the smart phone 70. These results of detection are outputted to the main controller 98.

The power source section 96 supplies electric power stored in a battery (not illustrated) to the respective sections of the smart phone 70 in accordance with instructions of the main controller 98.

The main controller 98 is equipped with a microprocessor, operates in accordance with the control programs and control data that are stored in the storage section 88, and generally controls the respective sections of the smart phone 70. Further, in order to carry out voice communication and data communication through the wireless communication section 84, the main controller 98 is equipped with a mobile communication control function that controls the respective sections of the communication system, and application processing functions.

The application processing functions are realized by the main controller 98 operating in accordance with application software stored in the storage section 88. Examples of the application processing functions include an infrared communication function that controls the external input/output section 90 and carries out data communication with a facing device, an email function that carries out transmitting and receiving of emails, a Web browsing function that browses Web pages, and the like.

Further, the main controller 98 has an image processing function that displays footage on the display/input section 74 and the like, on the basis of image data (data of still images or video images) such as received data or downloaded streaming data. The image processing function is the function of the main controller 98 decoding the image data, carrying out image processings on these decoded results, and displaying images on the display/input section 74.

Moreover, the main controller 98 executes display control with respect to the display panel 74A, and operation detection control that detects user operation through the operation section 80 and the operation panel 74B.

The main controller 98 displays icons for starting-up application software, and software keys such as a scroll bar and the like, or displays a window for creating email, by executing the display control. Note that a scroll bar is a software key for receiving instructions to move a displayed portion of an image, such as for a large image that cannot be contained within the display region of the display panel 74A.

Further, the main controller 98 detects user operation given through the operation section 80, and receives, through the operation panel 74B, operations with respect to the icons and the input of character strings in input fields of the window or receives requests to scroll a displayed image that were given through the scroll bar, by executing the operation detection control.

Moreover, the main controller 98 has a touch panel control function that judges, by executing operation detection control, whether the operated position of the operation panel 74B is the superposed portion (the display region) that is superposed on the display panel 74A, or is the outer edge portion (the non-display region) that is other than the display region and is not superposed on the display panel 74A, and that controls the sensitive regions of the operation panel 74B and the displayed positions of software keys.

Further, the main controller 98 may detect gesture operations with respect to the operation panel 74B, and may execute preset functions in accordance with the detected gesture operations. A gesture operation means operations of drawing a locus with respect to at least one of plural positions by drawing a locus by a finger or the like, designating plural positions simultaneously, or combinations of these operations, and is not a conventional simple touch operation.

The camera section 82 is a digital camera that carries out electronic imaging by using image pickup elements such as CMOSs (Complementary Metal Oxide Semiconductors) or CCDs (Charge-Coupled Devices) or the like. Under control of the main control section 98, the camera section 82 may convert image data obtained by image pickup into image data that is compressed in, for example, JPEG (Joint Photographic coding Experts Group) or the like, and may record the image data in the storage section 88 or output the image data through the input/output section 90 or the wireless communication section 84. Although the camera section 82 is disposed on the same surface as the display/input section 74 at the smart phone 70 illustrated in FIG. 14, the position where the camera section 82 is disposed is not limited to this. The camera section 82 may be disposed at the back surface of the display/input section 74, or plural camera sections 82 may be provided. In a case in which plural camera sections 82 are provided, image capturing can be carried out singly by switching the camera section 82 that is used in image capturing, or image capturing can be carried out by using the plural camera sections 82 simultaneously.

Further, the camera section 82 may be utilized in the various types of functions of the smart phone 70. For example, an image acquired at the camera section 82 may be displayed on the display panel 74A, or an image of the camera section 82 may be used as one operation input of the operation panel 74B. At the time when the GPS receiving section 92 detects the position, the GPS receiving section 92 may detect the position by referencing the image from the camera section 82. Moreover, the optical axis direction of the camera section 82 of the smart phone 70 may be judged or the current usage environment may be judged, by referencing an image from the camera section 82 with or without sing the triaxial acceleration sensor. Images from the camera section 82 may also be utilized within application software.

In addition, position information acquired from the GPS receiving section 92, voice information acquired from the microphone 78 (which may be text information obtained by the controller or the like converting a voice text), posture information acquired from the motion sensor section 94, or the like may be added to image data of still images or video images, and such images with information added thereto may be recorded in the storage section 88, or may be outputted through the input/output section 90 or the wireless communication section 84.

What claimed is:

1. An imaging device comprising:
a plurality of imaging units that capture, continuously and one frame at a time, a same object of imaging from a plurality of different viewpoints respectively;
a detection unit that detects a subject from respective images of the frames captured by any one of the plurality of imaging units;
a range computing unit that, if a plurality of subjects are detected by the detection unit, computes a range expressed by a difference between a maximum value and a minimum value among values relating to distances between the respective detected subjects at the respective frames in which the plurality of subjects have been detected and a corresponding imaging unit of the imaging units;
an adjusting unit that, if a difference between a range of a specific frame, whose range has been computed by the range computing unit, and a range of a frame captured immediately before or after the specific frame, exceeds a predetermined threshold value, adjusts the range of the specific frame such that the difference is reduced;
a parallax amount computing unit that computes a parallax amount corresponding to the range computed by the range computing unit or the range adjusted by the adjusting unit, based on a predetermined relationship between ranges and parallax amounts;
a stereoscopic image generation unit that generates a stereoscopic image corresponding to each frame, from a plurality of viewpoint images captured by the respective imaging units, based on the parallax amount computed by the parallax amount computing unit; and
a recording control unit that effects control so as to record, at a recording unit, the stereoscopic image generated by the stereoscopic image generation unit,
wherein the detection unit determines whether or not a subject that has been detected in a frame immediately before a target frame of detection is detected in the target frame and, based on a result of the determination, the range computing unit performs computation of a range or the adjusting unit performs adjustment of a range.

2. The imaging device of claim 1, wherein the recording control unit effects control so as to record, at the recording unit and in correspondence with the stereoscopic image, a parallax amount corresponding to the range adjusted by the adjusting unit.

3. The imaging device of claim 1, further comprising a receiving unit that receives input of information expressing a display format of the stereoscopic image,
wherein the stereoscopic image generation unit generates the stereoscopic image in a format that is adapted to the display format of the stereoscopic image expressed by the information received by the receiving unit.

4. The imaging device of claim 1, further comprising an input unit that inputs, from a connected display device, information expressing a display format of a stereoscopic image,
wherein the stereoscopic image generation unit generates the stereoscopic image in a format that is adapted to the display format of the stereoscopic image expressed by the motion input from the input unit.

5. The imaging device of claim 1, wherein the values relating to distances are distances between the respective detected subjects and the corresponding imaging unit, or parallaxes of the respective detected subjects.

6. The imaging device of claim 1, wherein, if the subject that has been detected in the frame immediately before the target frame is not detected in the target frame, the adjusting unit determines that a difference between a range of the target frame and a range of the frame immediately before the target frame exceeds the predetermined threshold value, and adjusts the range of the target frame.

7. The imaging device of claim 1, wherein, if the subject that has been detected in the frame immediately before the target frame is detected in the target frame, the range computing unit computes an amount of movement between frames of the subject detected by the detection unit, and computes the range by excluding a subject for which the amount of movement exceeds a predetermined amount of movement.

8. The imaging device of claim 7, wherein the range computing unit excludes a subject for which a direction of movement of the subject is a direction along an optical axis of the corresponding imaging unit and for which the amount of movement exceeds the predetermined amount of movement.

9. The imaging device of claim 1, further comprising a registering unit that registers, in advance, a subject to be detected by the detection unit,
wherein, if a subject that has been registered by the registering unit is detected by the detection unit, the range computing unit computes the range by using the registered subject.

10. The imaging device of claim 7, further comprising a registering unit that registers, in advance, a subject to be detected by the detection unit,
wherein the range computing unit computes the range by excluding a subject for which the amount of movement exceeds the predetermined amount of movement and that is a subject that is not registered by the registering unit.

11. The imaging device of claim 7, further comprising a registering unit that registers, in advance, a subject to be detected by the detection unit,
wherein the range computing unit does not exclude, from computation of the range, a subject for which the amount of movement exceeds the predetermined amount of movement, if the subject is a subject registered by the registering unit.

12. The imaging device of claim 1, wherein, if one subject is detected by the detection unit, the parallax amount computing unit computes the parallax amount by using the subject as a crosspoint, and, if a subject is not detected by the detection unit, the parallax amount computing unit computes the parallax amount by using a predetermined point as the crosspoint.

13. An imaging method comprising:
capturing, by a plurality of imaging units, continuously and one frame at a time, a same object of imaging from a plurality of different viewpoints respectively;
detecting a subject from respective images of the frames captured by any one of the plurality of imaging units;
if a plurality of subjects are detected, computing a range expressed by a difference between a maximum value and a minimum value of values relating to distances between the respective detected subjects at the respective frames in which the plurality of subjects have been detected and a corresponding imaging unit of the imaging units;
if a difference between a range of a specific frame, whose range has been computed, and a range of a frame captured immediately before or after the specific frame, exceeds a predetermined threshold value, adjusting the range of the specific frame such that the difference is reduced;
computing a parallax amount that corresponds to the computed range or the adjusted range, based on a predetermined relationship between ranges and parallax amounts;
generating a stereoscopic image corresponding to each frame, from a plurality of viewpoint images that have been captured by the respective imaging units, based on the computed parallax amount; and
recording, at a recording unit, the generated stereoscopic image,
wherein the detecting includes determining whether or not a subject that has been detected in a frame immediately before a target frame of detection is detected in the target frame and the computing of a range or the adjusting of a range is performed based on a result of the determination.

14. A non-transitory computer-readable storage medium that stores a program that causes a computer to execute imaging processing, the imaging processing comprising:
detecting a subject from respective images of the frames captured by any one of the plurality of imaging units;
if a plurality of subjects are detected, computing a range expressed by a difference between a maximum value and a minimum value of values relating to distances between the respective detected subjects at the respective frames in which the plurality of subjects have been detected and a corresponding imaging unit of the imaging units;
if a difference between a range of a specific frame, whose range has been computed, and a range of a frame captured immediately before or after the specific frame, exceeds a predetermined threshold value, adjusting the range of the specific frame such that the difference is reduced;
computing a parallax amount that corresponds to the computed range or the adjusted range, based on a predetermined relationship between ranges and parallax amounts;
generating a stereoscopic image corresponding to each frame, from a plurality of viewpoint images that have been captured by the respective imaging units, based on the computed parallax amount; and
recording, at a recording unit, the generated stereoscopic image,
wherein the detecting includes determining whether or not a subject that has been detected in a frame immediately before a target frame of detection is detected in the target frame and the computing of a range or the adjusting of a range is performed based on a result of the determination.
